(19) United States
(12) Patent Application Publication
(10) Pub. No.: US 2017/0114934 A1
(43) Pub. Date: Apr. 27, 2017

(54) POPPET VALVE ARRANGEMENT

(71) Applicant: Fjell Subsea Products AS, Kokstad (NO)

(72) Inventors: Asbjorn Strand, Nesttun (NO); Kristian Karlsen, Stanghelle (NO)

(73) Assignee: Fjell Subsea Products AS, Kokstad (NO)

(21) Appl. No.: 15/318,952

(22) PCT Filed: Jun. 19, 2015
(86) PCT No.: PCT/EP2015/063874

§ 371 Date: Dec. 14, 2016

(30) Foreign Application Priority Data
Jun. 19, 2014 (NO) 20140775

(51) Int. Cl. F16L 29/04; F16K 27/02; F16L 15/00; F16K 11/04

(52) U.S. Cl. CPC F16L 29/04; F16K 11/04; F16K 27/0263; F16L 15/006

(57) ABSTRACT

A poppet valve arrangement is described such as can be used in a pipe terminal and/or flow coupler, said arrangement comprising: a poppet valve comprising a biasing device; and a housing comprising an inlet, an outlet and a flow channel configured to provide fluid communication between said inlet and said outlet when said poppet valve is open; wherein: said fluid communication provided by said flow channel is blocked by the poppet valve under action of said biasing device when the poppet valve is closed; and the poppet valve is supported with respect to the housing by a channel splitter that radially sections the flow channel into a sectioned substantially annular flow channel portion around the poppet valve.

The present disclosure relates to a poppet valve arrangement, such as can be used in a pipe terminal and/or flow coupler. More specifically, aspects relate to a fluid transport system, coupling system, flow coupler and pipe terminals comprising such an arrangement, methods of constructing such terminals and flow couplers, methods of terminating pipes and a method of opening a valve connection between two pipes.

The apparatus and methods disclosed herein can be used in the termination and/or coupling of any fluid-carrying pipes, but are particularly suitable for deep subsea high pressure applications such as hydraulic control systems for oil and gas offshore wells.

A poppet or mushroom valve can be used in a first pipe terminal in such a way that, when coupled to a second pipe terminal, flow can be opened from one pipe into the other, but when the pipe terminals are separated from one another the poppet valve prevents leakage from the end of the first pipe. Poppet valves typically comprise a stopper portion whose default position is sitting within a housing such that a flow channel through that housing is completely closed off. A biasing device such as a spring, fixed to the housing, is generally used to maintain this default position. When first and second terminals are brought together to form a flow coupler, a structure of the second terminal acts against the biasing device to move the stopper portion out of its ‘seat’ in the housing, opening up flow between the stopper portion and the housing.

Some flow couplers comprise interlocking male and female terminals which, when connected, cause respective poppet valves comprised within each terminal to open one another. To achieve this, each poppet valve comprises an armature extending from its stopper portion which pushes against the armature of the other poppet valve to open it when the terminals are connected.

In such flow couplers, the flow generally runs substantially annularly around the mated poppet armatures and the poppets are supported with respect to the terminal housings by structures on the other side of the stopper sections to the armatures. For example, in some designs the support structure forms a ‘cup’ extending across a substantially cylindrical flow channel at the pipe end of the terminal, the flow entering said cup axially and exiting it through one or more substantially radial-going apertures to take the flow out annularly around the mated poppets.

The inventors have observed that existing poppet-based flow couplers introduce significant pressure drops and turbulence into fluids flowing through them. What is needed is an improved poppet valve arrangement which reduces these effects.

According to a first aspect, there is provided a poppet valve arrangement comprising a poppet valve and a housing. Said poppet valve comprises a biasing device. Said housing comprises an inlet, an outlet and a flow channel configured to provide fluid communication between said inlet and said outlet when the poppet valve is open. Said fluid communication provided by said flow channel is blocked by the poppet valve under action of said biasing device when the poppet valve is closed. The poppet valve is supported with respect to the housing by a channel splitter that radially sections the flow channel into a sectioned substantially annular flow channel portion around the poppet valve.

Said channel splitter can radially section said sectioned substantially annular portion along at least some of the biasing device's axial extent.

Said channel splitter can comprise a guiding support in contact with an interior wall of said housing but moveable with respect to said interior wall.

Said guiding support can be a cam extending from a body portion of the poppet valve.

Said guiding support can be a ball bearing.

Said sectioned substantially annular flow channel can comprise three radial sections.

Said biasing device can comprise a spring.

Coils of said spring can be substantially shielded from the flow channel by a spring cover.

Coils of said spring can encircle the flow channel.

Said channel splitter can comprise said spring cover.

The flow channel can be bounded only by an external surface of a moveable part of the poppet valve and an interior wall of the housing.

Said interior wall of the housing can comprise said spring cover.

The moveable part of the poppet valve and said interior wall of the housing can have corresponding profiles around at least a portion of their circumferences such that the width of the flow channel in said portion is substantially constant.

The flow channel can have a substantially constant hydraulic diameter from the pipe to the coupler end, said hydraulic diameter being substantially equal to the hydraulic diameter of said pipe.

The flow channel can comprise a substantially cylindrical portion in one of the inlet and the outlet, said sectioned substantially annular portion around a body of the poppet valve and a substantially annular portion around an armature of the poppet valve extending into the other of the inlet and the outlet.

The flow channel can further comprise a first substantially conical annular portion linking said substantially cylindrical portion to said sectioned substantially annular portion.

Said first substantially conical annular portion can have a cone angle between 1 and 30°, optionally between 5 and 30°, optionally 20°.

The flow channel can further comprise a second substantially conical annular portion linking said sectioned substantially annular portion to said substantially annular portion.

Said second substantially conical annular section can have a cone angle between 1 and 60°, optionally between 30 and 60°, optionally 45°.

The poppet valve can comprise an armature at a distal end thereof, said armature extending from a substantially conical stopper portion configured to be biased into mating with a corresponding substantially conical portion of an internal wall of the housing when the poppet valve is closed, under action of the biasing device.

The first poppet valve can further comprise a body portion formed separately to said stopper portion and said armature, a sealing ring. At least one of said body portion and the stopper portion can comprise a screw thread. The body portion and the stopper portion can be screwed together so as to trap an inner perimeter of said sealing ring therebetween, an outer perimeter of the sealing ring remaining exposed to the flow channel.

The stopper portion can comprise a first screw thread and the body portion can comprise a second screw thread corresponding to said first screw thread, the stopper portion being screwed into the body portion.

According to a second aspect there is provided a terminal for terminating a fluid-carrying pipe, said terminal comprising the poppet value of the first aspect configured to terminate said pipe when the poppet valve is closed.

The poppet valve can cooperate with a corresponding poppet valve of another terminal to open both poppet valves.

The poppet valve can comprise a coupler end configured to cooperate with said corresponding poppet valve of said other terminal, and a substantially conical pipe end opposing said coupler end.

Each poppet valve can comprise an armature having a coupler end configured to interlock with the other poppet valve armature coupler end.

One of the poppet valve armature coupler ends can be formed as a male connector and the other as a female connector corresponding to said male connector.

Said male connector can be substantially conical.

One of the inlet and the outlet can comprise a nozzle and the other of the inlet and the outlet can comprise a mating part configured to cooperate with a corresponding mating part of another terminal to open the poppet valve.

Said nozzle and said mating part can be sealed together by an electron beam welded joint.

Said mating part thereof can be a plug.

Said mating part thereof can be a socket.

The terminal according to the second aspect can be for use in a subsea environment.

According to a third aspect there is provided a flow coupler comprising the terminal of the second aspect and said other terminal.

Said mating parts can be configured to fit together in a watertight manner.

The flow channel can be a mirror image of a corresponding flow channel in the other terminal.

The flow channels can be mirror images of one another in a plane in which the poppet valves meet when they are cooperating with one another.

The other terminal can comprise a biasing device and a housing. The biasing devices of the two terminals can be configured such that their poppet valves are each displaced relative to their respective housings by substantially the same distance when they are cooperating with one another, compared to their respective positions relative to their respective housings when they are not cooperating with one another.

According to a fourth aspect there is provided a fluid transport system comprising the flow coupler of the third aspect, the pipe terminated by the terminal of the second aspect and a pipe terminated by said other terminal.

According to a fifth aspect there is provided a coupling system comprising a plurality of the terminals of the second aspect fixed into a connector plate.

According to a sixth aspect there is provided a coupling system comprising a first and second housing, a first and second poppet valve, and a first and second channel splitter. The first housing comprises a first pipe end and a first coupler end. The first poppet valve within said first housing, comprises a first biasing device and a first stopper, said first biasing device being arranged to bias said first stopper towards a position in which a first flow channel for providing fluid communication between said first pipe end and said first coupler end is blocked. The first channel splitter is arranged to radially section a first substantially annular portion of said first flow channel. The second housing comprises a second pipe end and a second coupler end. The second poppet valve within said second housing, comprises a second biasing device and a second stopper, said second biasing device being arranged to bias said second stopper towards a position in which a second flow channel for providing fluid communication between said second pipe end and second coupler end is blocked. The second channel splitter is arranged to radially section a second substantially annular portion of said second flow channel. The first and second housings are configured to cooperate with one another such that the first and second biasing devices act against one another to open said first and second poppet valves, permitting fluid communication between the first and second pipe ends.

According to a seventh aspect there is provided a method of constructing a terminal for terminating a fluid-carrying pipe, said method comprising constructing a poppet valve comprising a biasing device, a body section, a stopper section and an armature. Fixing said poppet valve within a mating housing comprising a pipe end and a coupler end such that said body, said stopper section and said armature are free to move within said mating housing under the action of said biasing device, the biasing device being arranged to bias said stopper section towards a position in which a flow channel for providing fluid communication between said pipe end and said coupler end is blocked. Fixing a nozzle to the pipe end of the mating housing using electron beam welding wherein said fixing is performed such that the poppet valve is supported with respect to the housing by a channel splitter that radially sections the flow channel into a sectioned substantially annular flow channel portion around the poppet valve.

The poppet valve can further comprise a sealing ring and said step of constructing the poppet valve can comprise screwing the body section and the stopper section together so as to trap an inner perimeter of said sealing ring therebetween, an outer perimeter of the sealing ring remaining exposed.

Screwing the body section and the stopper section together can comprise screwing a threaded part of the stopper section into a correspondingly threaded part of the body section.

According to an eighth aspect there is provided a method of constructing a flow coupler, said method comprising constructing two terminals according to the method of the seventh aspect, one of the mating housings being male and the other female, and inserting said male housing into said female housing.

Said method can comprise inserting said plug of the terminal of the second aspect, into a socket of said other terminal; or inserting a plug of said other terminal into said socket of the terminal of the second aspect.

According to a ninth aspect there is provided a method of terminating a pipe, said method comprising constructing a terminal according to the method of the seventh aspect and sealing said nozzle to an end of said pipe.

According to a tenth aspect there is provided a method of terminating a pipe, said method comprising sealing the nozzle of the terminal of the second aspect to an end of said pipe.

According to a eleventh aspect there is provided a method of opening a valve connection between first and second fluid-carrying pipes, said method comprising simultaneously opening the poppet valve of a terminal of said first pipe according to the second aspect and the poppet valve of the other terminal, which terminates said second pipe, by mutual action of the poppet valves upon one another.

Said simultaneous opening can be achieved by inserting a male housing of the terminal of the first pipe into a female housing of the terminal of the second pipe.

According to a twelfth aspect there is provided a poppet valve arrangement substantially as herein described, with reference to the accompanying figures.

According to a thirteenth aspect there is provided a terminal for terminating a fluid-carrying pipe substantially as herein described, with reference to the accompanying figures.

According to a fourteenth aspect there is provided a coupling system substantially as herein described, with reference to the accompanying figures

According to a fifteenth aspect there is provided a flow coupler substantially as herein described, with reference to the accompanying figures.

According to a sixteenth aspect there is provided a fluid transport system substantially as herein described, with reference to the accompanying figures.

According to a seventeenth aspect there is provided a method of constructing a terminal for terminating a fluid-carrying pipe substantially as herein described, with reference to the accompanying figures.

According to a eighteenth aspect there is provided a method of constructing a flow coupler substantially as herein described, with reference to the accompanying figures.

According to a nineteenth aspect there is provided a method of terminating a pipe substantially as herein described, with reference to the accompanying figures.

According to a twentieth aspect there is provided a method of opening a valve connection between first and second fluid-carrying pipes substantially as herein described, with reference to the accompanying figures.

Aspects of the present invention will now be described by way of example with reference to the accompanying figures. In the figures:

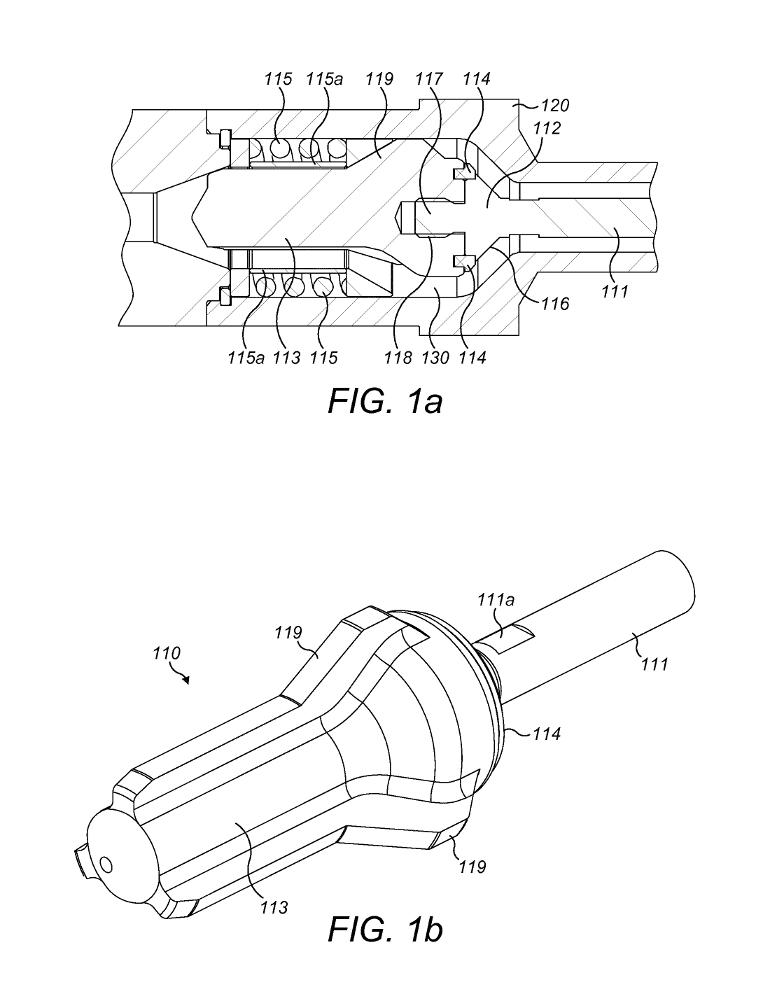

FIG. 1a illustrates an example poppet valve arrangement when open;

FIG. 1b provides a perspective view of the example poppet valve shown in FIG. 1a;

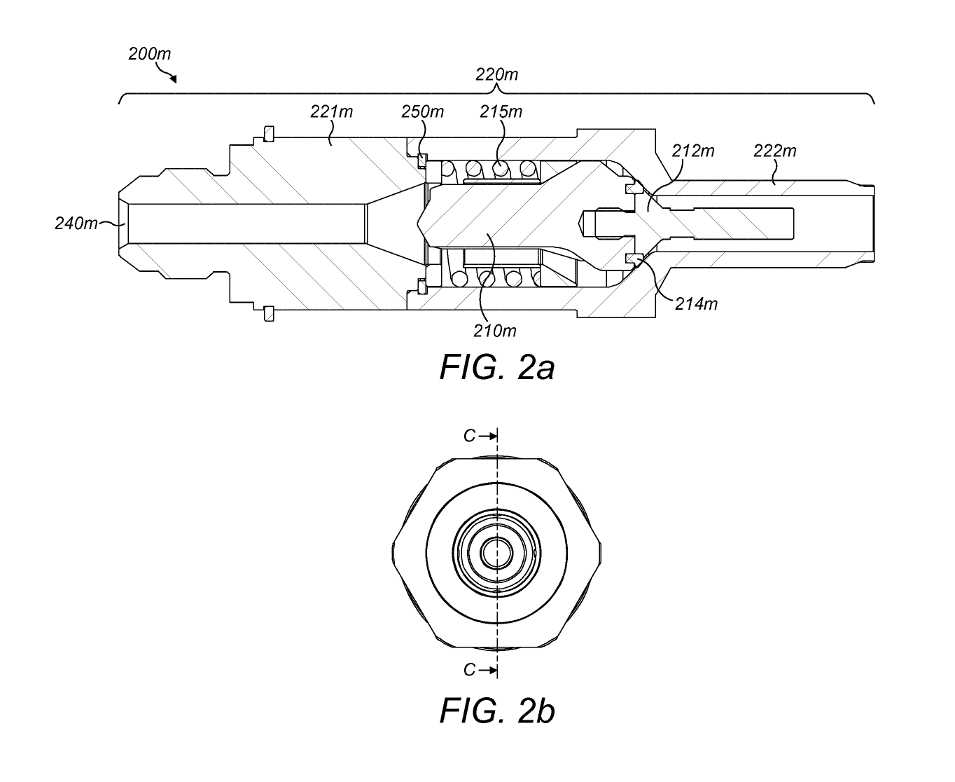

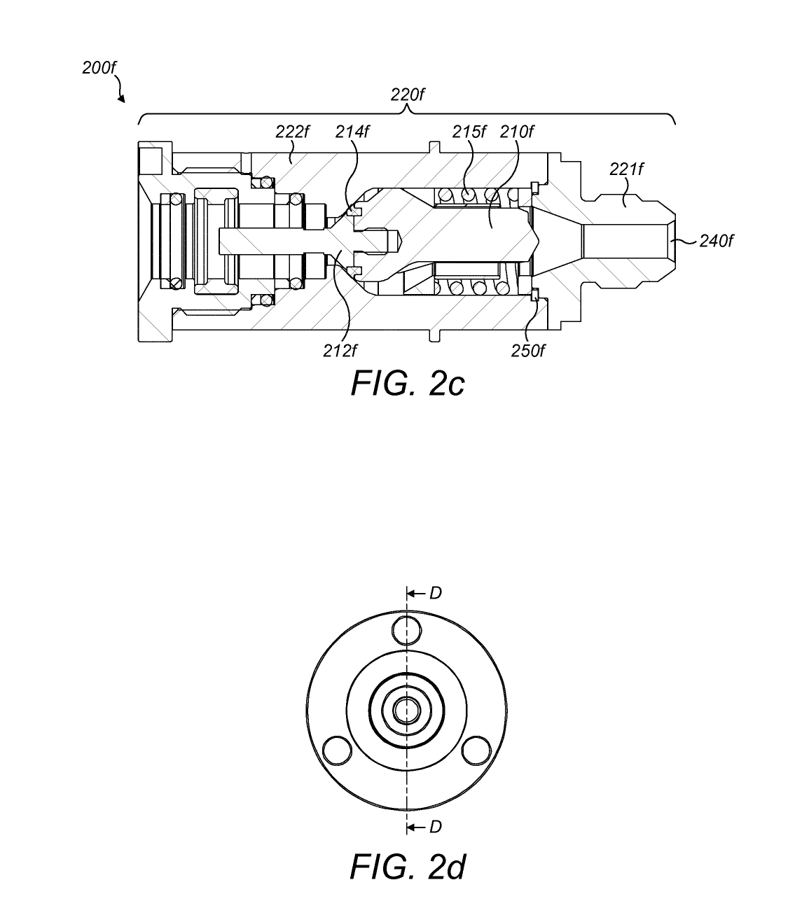

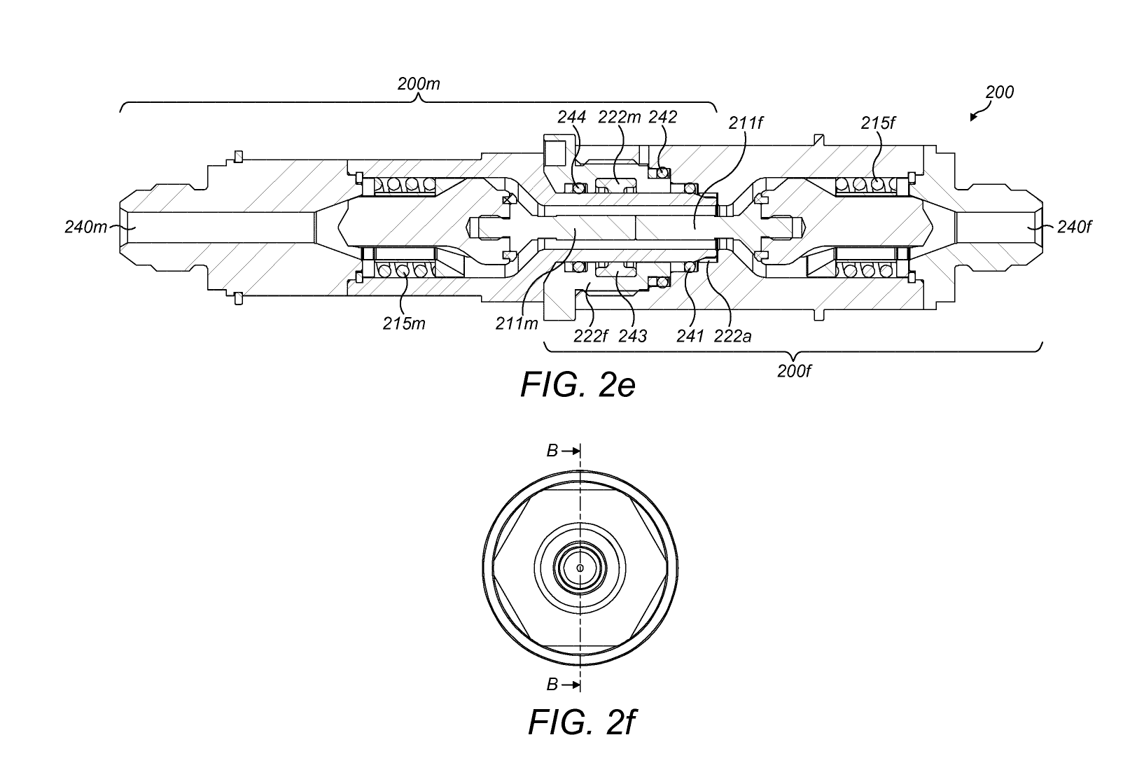

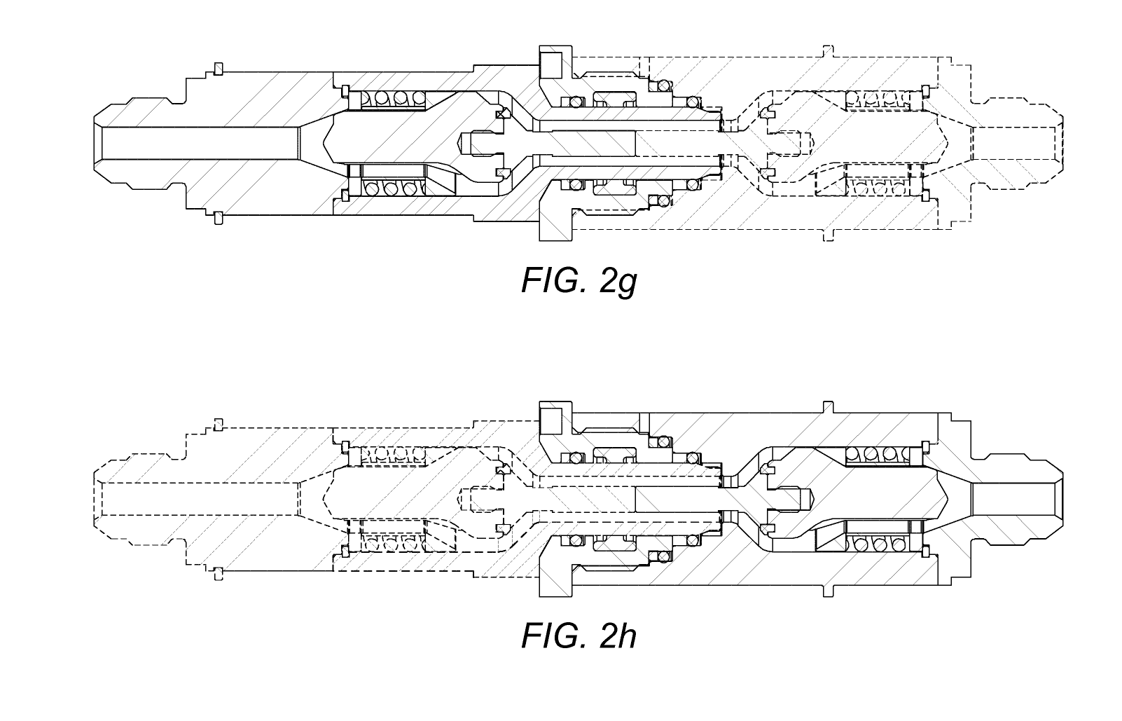

FIGS. 2a and 2b illustrate an example male terminal comprising the poppet valve arrangement of FIG. 1a, with the poppet valve closed;

FIGS. 2c and 2d illustrate an example female terminal comprising the poppet valve arrangement of FIG. 1a, with the poppet valve closed;

FIGS. 2e to 2h illustrate an example flow coupler comprising the male terminal of FIGS. 2a and 2b plugged into the female terminal of FIGS. 2c and 2d such that their poppet valves open one another;

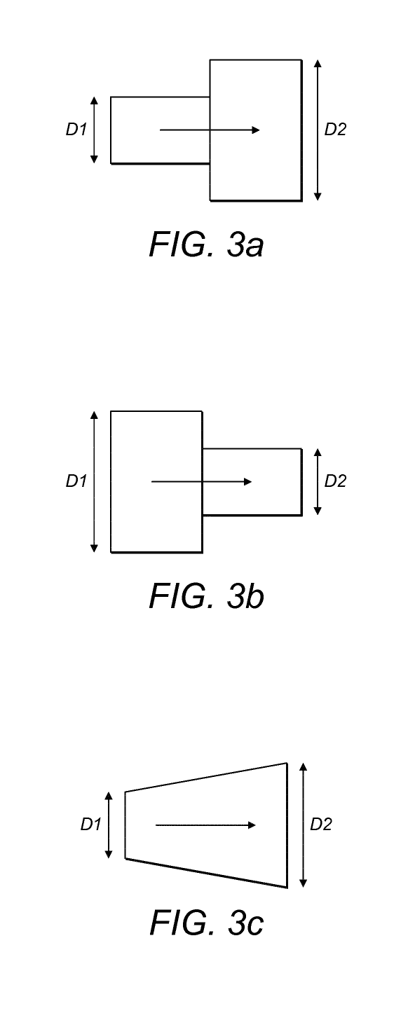

FIGS. 3a to 3c illustrate different types of flow channel diameter transitions;

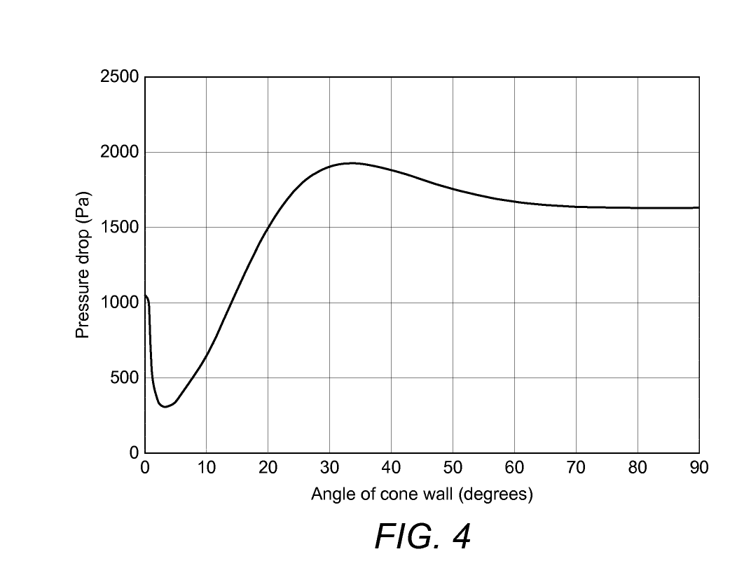

FIG. 4 shows the pressure drop expected as a result of a gradual transition between flow channels of different diameters, said transition being characterised by various cone angles;

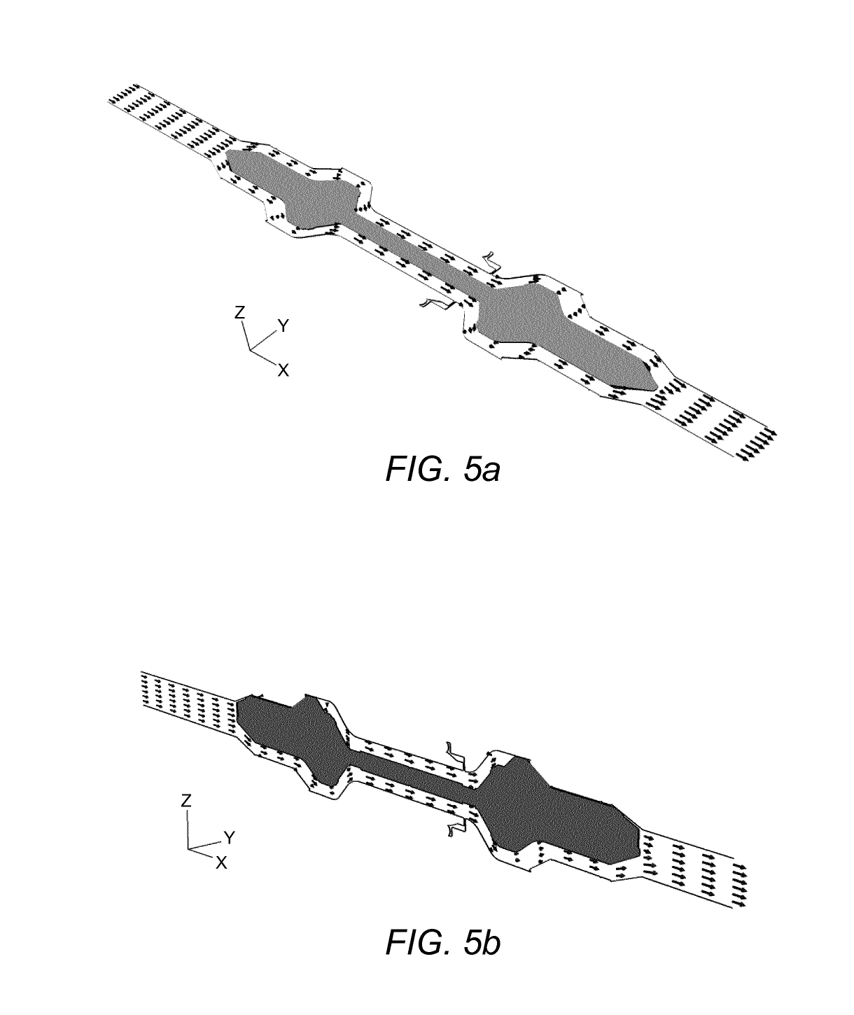

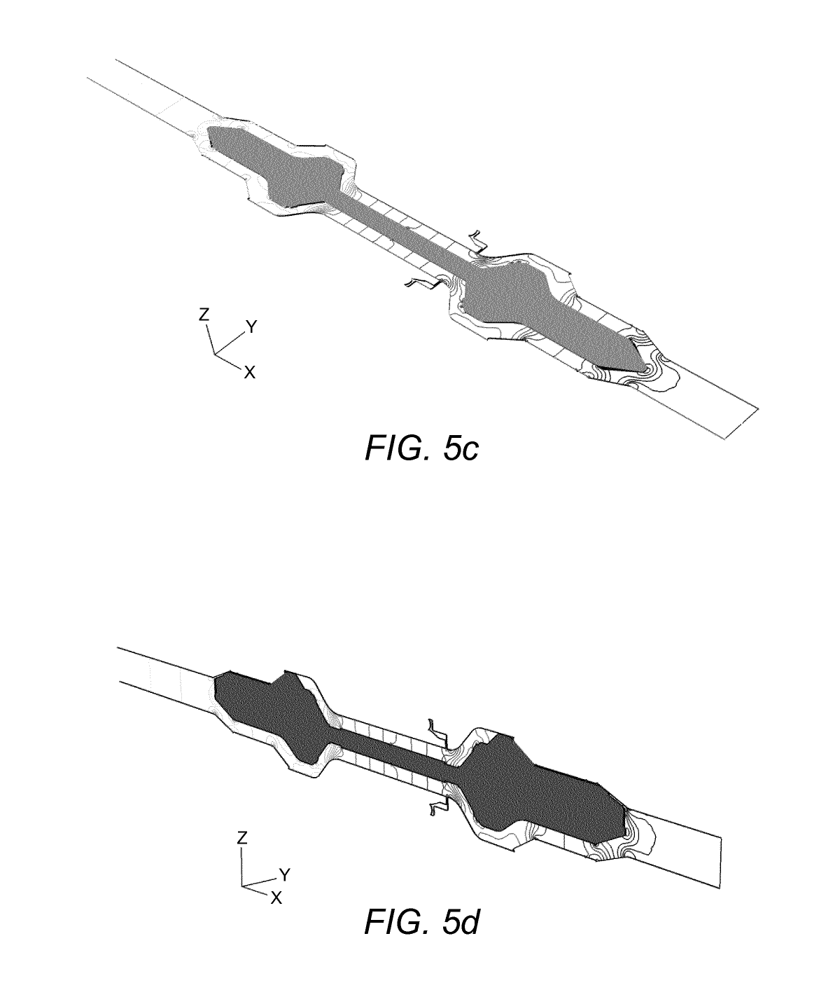

FIGS. 5a and 5b illustrate a velocity field through the flow coupler of FIGS. 2e to 2h;

FIGS. 5c and 5d illustrate a pressure field through the flow coupler of FIGS. 2e to 2h;

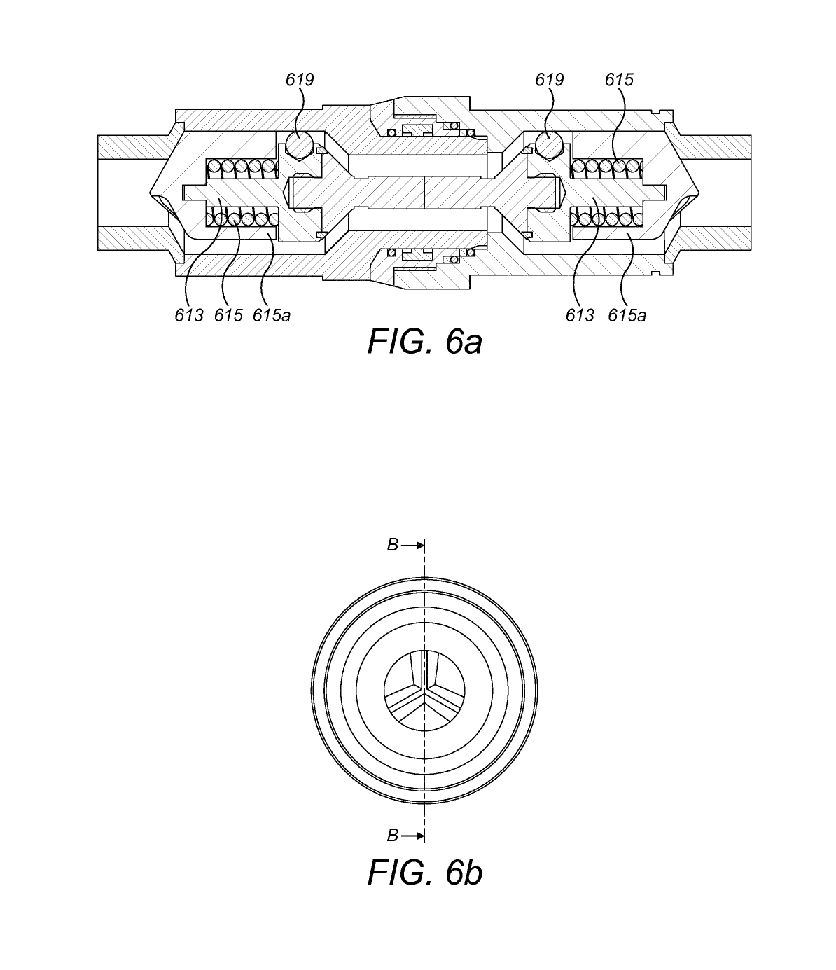

FIGS. 6a and 6b illustrate another example flow coupler;

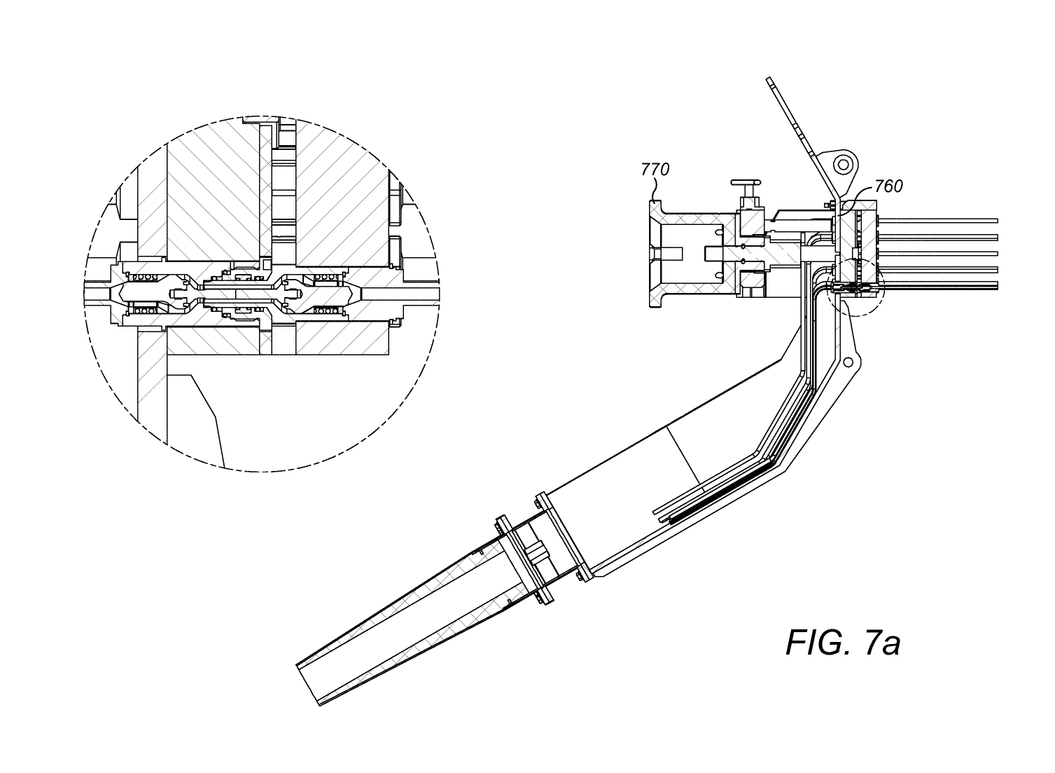

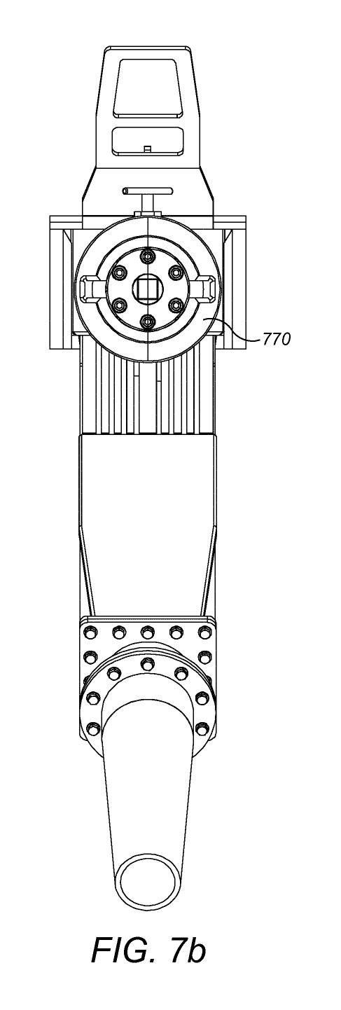

FIGS. 7a and 7b illustrate example multiple quick connect stab plates for holding a plurality of the flow couplers of FIGS. 2e to 2h; and

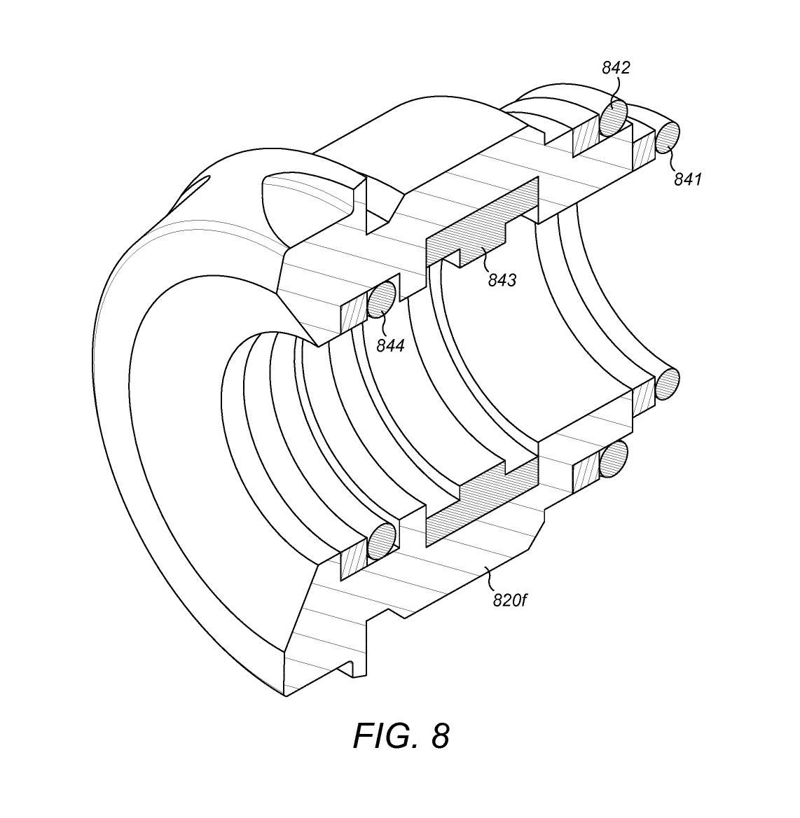

FIG. 8 illustrates an example sealing arrangement for the flow coupler of FIGS. 2e to 2h.

The following description is presented to enable any person skilled in the art to make and use the system, and is provided in the context of a particular application. Various modifications to the disclosed embodiments will be readily apparent to those skilled in the art.

There are described herein examples of poppet valve arrangements in which the poppet valve is supported with respect to its housing by a structure referred to herein as a ‘channel splitter’. The channel splitter radially sections the flow channel around at least a portion of the poppet. The present inventors have recognised that it is not required for the structure supporting the poppet valve within the housing to extend all the way across the diameter of the substantially cylindrical flow channel which the poppet valve arrangement interrupts, and thus that the substantially radial-going apertures described above are not required. Squeezing flow through small apertures and sharply changing the flow's direction both result in pressure drops and increased turbulence. In contrast, the example poppet valve arrangements described herein provide much more streamlined flow channels.

FIG. 1a illustrates an example poppet valve arrangement. As shown, the left hand side of the image would connect to a fluid-carrying pipe and the right hand side would either terminate that pipe or connect to another similar poppet valve arrangement to form a flow coupler. The poppet valve is in the open position as illustrated.

Poppet valve 110, which is illustrated (without its spring) in perspective view in FIG. 1b, comprises an armature 111, stopper section 112, body section 113, sealing ring 114 and spring 115. Embodiments include other shapes and forms of poppet valve which can perform the same function as the illustrated poppet valve.

Armature 111 is substantially cylindrical. It is rigid enough to push against another similar armature when the poppet valve arrangement is used in a flow coupler.

Stopper section 112 has a truncated cone-shaped exterior profile 116 at its coupler end (adjoining the armature). It has a threaded screw 117 at its pipe end (with the thread indicated by 118).

Body section 113 comprises a correspondingly threaded recess into which screw 117 is screwed. Stopper section 112 and body section 113 are screwed together so as to trap sealing ring 114 between them in a groove circumscribing one or both of the body and stopper sections around the point their external surfaces meet. (One or more features such as recess 111a can be provided on one or more of armature 111, stopper section 112 and body section 113 to facilitate coupling of a tool, or fingers, thereto to screw the body and stopper sections together tightly.) A portion of the external surface of the sealing ring extends slightly radially outwards relative to the body and stopper section external surfaces.

The body section 113 comprises guiding supports in the form of three protrusions 119 from the body section 113, which may be referred to as cams (though they do not undergo substantial rotary motion with respect to the housing), distributed evenly around the circumference of the poppet body (only one being shown in the cross section of FIG. 1a).

Helical spring 115 circumscribes the pipe end of the body section 113 and is affixed thereto by the pipe ends of the cams.

The pipe end surface of the body section 113 is formed to encourage smooth fluid flow around it. As shown it is in the form of a rounded cone, but other forms could be used, for example a flared spike that follows a smooth curve down to the body section side surfaces.

The poppet valve 110 is enclosed by a housing 120. Spring 115 is fixed to the interior wall of the housing 120. The profile of the housing substantially matches that of the poppet in the regions not interrupted by the cams. A three way channel 130 is thus formed between the poppet and the housing.

The channel 130 is shielded from spring 115 by a spring cover 115a in the form of a housing or bushing. Turbulence is therefore not introduced to the flow as a result of it being repeatedly interrupted by spring coils. The spring cover could completely enclose the spring, or could deflect the flow away from it so that any fluid surrounding its coils is substantially stagnant, i.e. not part of the main fluid flow through the coupler.

Viewed axially, the channel in the armature region is annular and the channel in the body region is a radially sectioned annulus, the annulus being interrupted at around 0°, 120° and 240° by the cams 119 and the spring cover 115a, which form the channel splitter referred to above. Since the support structure for the poppet overlaps the spring axially, this poppet arrangement is more compact than known arrangements in which the support structure is provided axially adjacent the spring.

The channel, for the entirety of its length, is always between the poppet and the housing, and is never completely enclosed by parts of the poppet. i.e. it always goes around the poppet, never through it. This is in contrast to some known designs of poppet valve arrangements in which the flow is constricted into one or more channels within the poppet itself and then forced through apertures in the poppet to allow it to run annularly around the armature. Such constrictions and apertures introduce changes in flow speed and direction that increase turbulence. The flow channel of the present disclosure flows smoothly around the poppet along as streamlined a route as possible.

The radial width of the each of the three branches of the channel is substantially the same, and is substantially constant along the axial length of the poppet. The walls of the channel are formed of substantially smooth curves.

The shapes, sizes and relative locations of the poppet 110 and housing 120 are chosen such that channel 130 has a substantially constant hydraulic diameter for its entire length. Further, said hydraulic diameter is arranged to be substantially equal to that of two pipes the poppet valve arrangement is intended to couple.

FIGS. 2a and 2b show the poppet arrangement of FIGS. 1a and 1b in use in a male pipe terminal 200m, viewed respectively in cross-section through the axis, perpendicular to it (as in FIG. 1a), and end-on. The poppet arrangement is shown in FIGS. 2a and 2b closing off the end of the pipe 240m.

Housing 220m is formed of nozzle 221m, sealed to pipe 240m, and plug 222m, sealed to the nozzle. Nozzle 221m and plug 222m are optionally sealed together by electron beam (EB) welding. A small stop ring 250m can be installed to keep the spring 215m pre-tensioned before welding. Otherwise some device would be necessary to press the parts together during welding, which would be difficult to introduce into the fully automated vacuum chamber EB welding process.

EB welding secures the precision, repeatability and bond durability required for high pressure subsea applications. Once an EB welding procedure has been tuned and qualified for tube welds for use in a subsea environment, non-destructive testing (NDT) on each weld formed by the process is not generally required since EB welding is such a repeatable, reliable technique. Generally, X-ray NDT is required to check for defects in welded joints for use subsea, and as such, the cavity in the region of the joint must be hollow so that shadows of internal components do not confuse the X-ray results. However, since if EB welding is used such NDT is not required, the housing can be made more compact as it is not a problem for the pipe end of the poppet to extend axially into or even beyond the weld region. This saves on material and transport costs, reduces the weight of the terminals and makes them easier to manoeuvre when connecting and disconnecting couplers.

When no external forces act on poppet 210m, the biasing action of spring 215m pushes it towards the coupler end of housing 220m such that stopper section 212m is forced into a narrowing portion of the inner wall of the housing, plugging the channel. If a sufficiently good plug can be achieved through contact between stopper section 212m and the housing inner wall, sealing ring 214m can be omitted. Sealing ring 214m however can be employed to improve the seal between the poppet 210m and housing 220m.

FIGS. 2c and 2d show the poppet arrangement of FIGS. 1a and 1b in use in a female pipe terminal 200f, viewed respectively in cross-section through the axis, perpendicular to it (as in FIG. 1a), and end-on. The poppet arrangement is shown in FIGS. 2c and 2d closing off the end of the pipe 240f.

Housing 220f is formed of nozzle 221f, sealed to pipe 240f, and socket 222f, sealed to the nozzle. Nozzle 221f and socket 222f are optionally sealed together by EB welding. As in the male terminal, a small stop ring 250f can be installed to keep the spring 215f pre-tensioned before welding.

When no external forces act on poppet 210f, the biasing action of spring 215f pushes it towards the coupler end of housing 220f such that stopper section 212f is forced into a narrowing portion of the inner wall of the housing, plugging the channel. As for the male terminal, if a sufficiently good plug can be achieved through contact between stopper section 212f and the housing inner wall, sealing ring 214f can be omitted. Sealing ring 214f however can be employed to improve the seal between the poppet 210f and housing 220f.

FIGS. 2e and 2f show flow coupler 200 in its entirety with male terminal 200m plugged into female terminal 200f, viewed respectively in cross-section through the axis, perpendicular to it (as in FIG. 1a), and end-on. FIGS. 2g and 2h show the view of FIG. 2e with respectively the female and male parts shown with dotted lines. The poppet armatures 211m and 211f meet in the middle and push on one another against springs 215m and 215f, settling in the position shown in which the substantially constant hydraulic diameter flow channels referred to above are opened up and linked to provide fluid communication between pipes 240m and 240f.

The internal parts of the male and female terminals are identical; the poppet arrangement of FIG. 1a is used in both. The coupler is thus formed by a modular system, reducing manufacturing costs and allowing for flexibility in combinations of poppet arrangements and housings.

The connection between plug 222m and socket 222f is a tight plug fit, except for a small gap 222a provided by a groove in the tip of the plug to prevent vacuum locking making the coupler difficult to disconnect. The coupler connection is sealed by primary seal 241, with redundancy provided by secondary seal 242, tertiary seal 243 and quaternary seal 244, which will be described in more detail below. Such redundancy is especially important for subsea applications where flow couplers may need to function without maintenance for several decades. Strict regulations also apply to seals in this context due to the pollution risk posed by leaking petroleum and other chemicals. As shown, all four seals are provided affixed to the socket 222f of female housing 220f. However, the seals could alternatively be provided on plug 222m of male housing 220m or on a combination of plug 222m and socket 222f.

Example dimensions in mm for the components illustrated in FIGS. 2a to 2h for various pipe diameters are as follows.

| | Sectioned | Sectioned | Poppet body | | | |
|---|---|---|---|---|---|---|
| | annular | annular | section | Annular | Annular | |
| Cylindrical | flow | flow | and | flow | flow | |
| pipe | channel | channel | stopper | channel | channel | Poppet |
| internal | inner | outer | section | inner | outer | armature |
| diameter | diameter | diameter | length | diameter | diameter | length |
| 5 | 6.2 | 10.1 | 40.5 | 3.9 | 7.8 | 15.6 |
| 8 | 7.4 | 12.0 | 48.2 | 4.6 | 9.3 | 18.5 |
| 11 | 8.6 | 14.0 | 55.8 | 5.4 | 10.8 | 21.5 |
| 14 | 9.3 | 15.0 | 60.2 | 5.8 | 11.6 | 23.1 |

The flow channel provided through the described flow coupler reduces pressure and speed changes through the coupler for the reasons described below. This is desirable since pressure/speed changes in the flow can introduce turbulence. The more turbulent the flow, the more erosion/degradation the internal parts of the coupler and pipes suffer. This is especially problematic in applications where maintenance/replacement of the coupler is difficult or impossible, and/or a long working lifetime is required, such as in deep subsea environments. Pressure drops will of course also impede fluid transport.

The Darcy-Weisbach equation for pressure loss is:

$$Δ p = f \cdot \frac{L}{{D}_{h}} \cdot \frac{ρ {u}^{2}}{2} \qquad ( 1 )$$

where the pressure loss due to friction Δp (Pa) is a function of:
the Darcy Friction Factor, f, a (dimensionless) coefficient of laminar or turbulent flow
the ratio of the length to hydraulic diameter of the pipe, L/Dₕ (dimensionless), where the hydraulic diameter of a cylindrical pipe is simply its inner diameter; and
the dynamic pressure, which depends on the density of the fluid, ρ (kg/m³) and the mean flow speed, u (m/s).

For example, the pressure drop for turbulent flow through a cylindrical pipe of dimensions similar to a typical flow coupler can be calculated from parameters Dₕ=6.35 mm, L=10 mm, u=2.2 m/s, ρ=1000 kg/m³ and f=0.03, where f is estimated using the Colebrook equation:

$$\frac{1}{\sqrt{f}} = - 2 {log}_{10} ( \frac{ɛ}{3.7 {D}_{h}} + \frac{2.51}{Re \sqrt{f}} ) \qquad ( 2 )$$

based on Reynolds number, Re=12,400 (where

$$Re = \frac{ρ \cdot u \cdot {D}_{h}}{μ} , \qquad ( 3 )$$

μ being the dynamic viscosity, 1.122×10⁻³ kg/m.s) and assuming a negligible roughness height, ε. This gives a pressure drop of 114 Pa.

In general the hydraulic diameter of a flow channel is given by:

$${D}_{h} = \frac{4 A}{P} . \qquad ( 4 )$$

where A is the cross sectional area and P is the wetted perimeter of the cross-section.

For an annulus the hydraulic diameter is thus simply the difference between the inner and outer diameters. Keeping the other parameters the same as previously, for an annular pipe of inner diameter 15.2 mm the outer diameter required to provide the same flow area, and thus the same speed, as the cylindrical pipe is \sqrt{(6.35 mm)²+(15.2 mm)²}=16.47 mm. Dₕ is thus 1.27 mm. f=0.045, again from the Colebrook equation (2). The pressure drop is thus 857 Pa, approximately 7.5 times that of the cylindrical pipe.

This increase in pressure drop in an annular pipe compared to a cylindrical pipe is due to frictional losses from having two wall boundary layers instead of one. As can be seen from equation (1), this effect could be mitigated by reducing the flow speed.

Consider an annular pipe in which the hydraulic diameter is the same as for the cylindrical pipe, so the available flow area is larger than for the annular pipe considered above, and thus the speed is lower. Dₕ=6.35 mm=Dₒ−Dᵢ (the difference between the inner and outer diameters), so if Dₒ is, say, 21.55 mm, Dᵢ must be 15.2 mm. The volume flow rate through the cylindrical pipe was

$$u = 6.97 {10}^{- 5} {m}^{3} \text{/} s .$$

So, keeping the volume flow rate and hydraulic diameter the same, the average flow speed through our annular pipe must be

$$\frac{4 \times 6.97 \times {10}^{- 5} {m}^{3} \text{/} s}{π ( {D}_{o}^{2} - {D}_{i}^{2} )} = 0.38 m \text{/} s .$$

Re in this case works out according to equation (3) as 2150, which indicates laminar flow, so f can be taken as 64/Re, giving a pressure drop of 3.4 Pa.

However, this small pressure drop is due to the low dynamic pressure. So, although friction losses are reduced with respect to the previous annulus, a large part of the dynamic pressure head is lost, which is detrimental to fluid transport. So a compromise must be struck wherein the inner and outer diameters of an annular channel through a flow coupler should be chosen so as to reduce flow speed in order to reduce frictional losses, but without reducing it so much the dynamic pressure head falls too low.

For the design illustrated in FIGS. 2a-h, if the average flow speed in the pipes is 2.2 m/s, it will be approximately 1.1 m/s in the largest annular channel. The resulting pressure drop over the 120 mm length of the coupler is 7758 Pa, in contrast to the 1368 Pa drop that would occur for a 6.35 mm inner diameter pipe of the same length.

Another consideration in coupler design is the transitions between the pipes and coupler and between various coupler sections.

Considering a step increase in cylindrical pipe diameter as shown in FIG. 3a, with the arrow showing the flow direction and parameters of

| Flow medium | Water 15° C./liquid | |
|---|---|---|
| Volume flow | 0.25 | m³/h |
| Weight density | 998.206 | kg/m³ |
| Dynamic Viscosity | 1122 × 10⁻⁶ | kg/ms |
| Element of pipe | Sudden expansion | |
| D1 | 6.35 | mm |
| D2 | 15.28 | mm |
| Speed of flow 1 | 2.19 | m/s |
| Reynolds number 1 | 12388 | |
| Speed of flow 2 | 0.38 | m/s |

| | |
|---|---|
| Reynolds number 2 | 5148 |
| Flow type | turbulent |
| Resistance coefficient | 22.95 |

the pressure drop can be calculated to be 1643 Pa, approximately two thirds of the dynamic pressure in the inlet flow.

For a mirrored step decrease in pipe diameter as shown in FIG. 3b, with parameters of

| Flow medium | Water 15° C./liquid | |
|---|---|---|
| Volume flow | 0.25 | m³/h |
| Weight density | 998.206 | kg/m³ |
| Dynamic Viscosity | 1122 10−6 | kg/ms |
| Element of pipe | Sudden contraction | |
| D1 | 15.28 | mm |
| D2 | 6.35 | mm |
| Speed of flow 1 | 0.38 | m/s |
| Reynolds number 1 | 5148 | |
| Speed of flow 2 | 2.19 | m/s |

| | |
|---|---|
| Reynolds number 2 | 12388 |
| Flow type | turbulent |
| Resistance coefficient | 0.43 |

the pressure drop is 1041 Pa, greater than the total dynamic pressure.

For a smooth transition from D1 to D2 as shown in FIG. 3c, the pressure drop varies with the half cone angle (i.e. the angle between the wall and the direction of flow) as shown in FIG. 4.

The minimum pressure drop is for an angle of 3° and the maximum for 33°. However, an angle of 3° is unlikely to be practical as this corresponds to a very long transition length of 85 mm.

For the design illustrated in FIGS. 2a-h, the angle between the inner housing wall and the axial flow chosen for the transition between the cylindrical pipe and the (partially) annular channel around the poppet body is 20°, though angles between 5 and 30° would be practical. The angle between the inner housing wall and the axial flow chosen for the transition between the (partially) annular channel around the poppet body and the annular channel around the poppet armature is 45°, though angles between 30 and 60° would be practical.

The velocity field for this design is shown in FIGS. 5a and 5b (wherein the length of the arrow indicates the speed of the flow) and FIGS. 5c and 5d show the pressure field (where crossing a contour line from left to right indicates a pressure drop of 250 Pa). FIGS. 5a and 5c show a top-down view in which the cams are not visible, while FIGS. 5b and 5d show a side-on view (as in FIG. 2e) where stagnation occurs around the cams. The model used was steady state for water at 15° C. with an inlet flow speed of 2.2 m/s. It can be seen that the regions around the stopper section of the poppet suffer the worst pressure losses. This is because in these regions flow optimisation must be balanced against the need to ensure a good seal is created when the coupler is disconnected.

FIGS. 6a and 6b illustrate an alternative coupler design viewed respectively in cross-section through the axis, perpendicular to it (as in FIG. 2e), and end-on (as in FIG. 2f). In this design, ball bearings 619 are used in place of cams. Instead of springs encircling the flow channel, springs 615 encircle the poppet body sections 613. They are still not exposed to the flow channel however, since they are covered by spring covers/housings 615a.

In this example, the channel splitter is provided by spring cover 615a and ball bearing 619. Again, at least a part of the channel splitter overlaps with the spring axially, allowing for a compact design.

The coupler ends of the armatures are shown in the figures as planar surfaces, perpendicular to the poppet axes. However, they could alternatively have surfaces shaped to interlock with one another. For example, the end of the armature of the male terminal's poppet could be in the form of a cone and the end of the armature of the female terminal's poppet could be in the form of a recess shaped to receive said cone, or vice-versa. Other interlocking shapes could be envisaged. Such an interlock would provide stability to the poppets with respect to their springs. The guiding supports, such as the cams or ball bearings described above, might therefore be done away with or made smaller if an armature end interlock is employed.

Though the poppet valves described herein comprise helical coil springs, any biasing means could be used. For example gas springs or leaf springs could be employed.

In the illustrated examples, three guiding supports are used (whether in the form of cams or ball bearings), dispersed at 120° angles around the poppet circumference. This ensures stable sliding of the poppet within the housing with the minimum disruption to the flow channel. However, even more stability could be provided by including further guiding supports. The guiding supports need not be evenly distributed around the poppet circumference so long as their number and location provide for stable sliding of the poppet.

FIGS. 7a and 7b show respectively a cross sectional side view and a front view of Multiple Quick Connect (MQC) stab plates 760 which can be used to connect and disconnect multiple (in this case 6) couplers at once. This can be done with the aid of an ROV (Remotely operated underwater vehicle) which has an arm which can be fitted into bucket 770. The ROV can then rotate its arm in one direction to simultaneously connect all the couplers, and in the other direction to simultaneously disconnect them.

FIG. 8 illustrates an example seal structure that could be used in a female coupler terminal. Housing 820f is provided with primary dynamic seal 841, which acts as a barrier against escape of the internal fluid and may, for example be elastomeric or metallic (the other seals will generally be elastomeric). Redundancy is provided by a static secondary seal 842 fixed between the two screwed parts of the female coupler, which does not face any sliding surfaces at any time. Quaternary dynamic seal 844 (for example an O-ring) acts as a barrier against ingress of seawater, with redundancy provided by dynamic tertiary seal 843, which can optionally be a T-seal as shown.

Different seal materials can be used depending on the circumstances. Spring energised PTFE is suitable for most applications. Elastoloy 985 is generally suitable for high temperature applications and Elastoloy 101 for low temperature applications. Fluor elastomer may be used for tough chemicals and high temperatures. A silver or gold coated Inconel (metallic) seal may be used for slurry, gas and very high temperatures. Different combinations of seals may also be appropriate depending on requirements. For example, the combinations shown in the following table might be used.

| | | Tough | | |
|---|---|---|---|---|
| | | chemical | | |
| | | and/or | | Sediment |
| | | high tem- | | present in |
| | Standard | perature | Low cost | fluid |
| Primary | Spring | Fluor | Elastoloy 985 | Silver or |
| | energised | elastomer | | gold coated |
| | PTFE | | | Inconel |
| Secondary | Elastoloy 101 | Fluor | Elastoloy 101 | Elastoloy 101 |
| | | elastomer | | |
| Tertiary | Elastoloy 985 | Fluor | Elastoloy 101 | Elastoloy 985 |
| | | elastomer | | |
| Quater- | Elastoloy 985 | Fluor | Elastoloy 985 | Elastoloy 985 |
| nary | | elastomer | | |

The poppet sealing ring will generally be provided in the same material as the primary seal.

Materials chosen for subsea flow couplers must adhere to certain standards, for example metallic component must meet the NORSOK M-001 standard. The lowest allowable stainless grade 316 is normally too weak for high pressure equipment, but a much used material for this type of equipment is the alloy with trade name NITRONIC 50 (UNS S20910) having chemistry 22% Cr, 12.5% Ni, 5% Mn, 2.25% Mo, 1% Si, 0.06% C, Fe to balance. This provides a combination of corrosion resistance, ease of manufacture and strength not found in any other commercial material available in its price range. To meet more stringent requirements and deal with high mechanical stresses and exposure to sea water high cost nickel alloys in the Inconel family, typically Inconel 625 (UNS N06625 and higher grades for springs), may be chosen (chemistry 58% Ni, 21.5% Cr, 9% Mo, 0.5% Mn, 0.1% C, 0.5% Si, 5% Fe). This has excellent mechanical properties at both extremely low and extremely high temperatures, outstanding resistance to pitting, crevice corrosion and inter-crystalline corrosion and almost complete freedom from chloride induced stress corrosion cracking. It is also easy to manufacture.

The apparatus and methods disclosed herein are particularly suited for subsea hydraulic control systems and chemical injection for oil and gas wells. However, they could also be applicable in other scenarios, including for example hydraulic and pneumatic power/braking systems, cooling circuits, water supply and fuelling systems. Applications could be found in industries such as aerospace, robotics, motorsport, transit, air conditioning, heavy machinery, agriculture, utility supply etc.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

1.-57. (canceled)

58. A poppet valve arrangement comprising:
a poppet valve comprising a biasing device; and
a housing comprising an inlet, an outlet and a flow channel configured to provide fluid communication between said inlet and said outlet when said poppet valve is open; wherein:
said fluid communication provided by said flow channel is blocked by the poppet valve under action of said biasing device when the poppet valve is closed; and
the poppet valve is supported with respect to the housing by a channel splitter that radially sections the flow channel into a sectioned substantially annular flow channel portion around the poppet valve;
wherein said channel splitter radially sections said sectioned substantially annular portion along at least some of the biasing device's axial extent; and
said channel splitter is provided along the length of the poppet valve such that the flow channel has a substantially constant hydraulic diameter from the pipe to the coupler end, said hydraulic diameter being substantially equal to the hydraulic diameter of said pipe.

59. The arrangement of claim 58, wherein said channel splitter comprises a guiding support in contact with an interior wall of said housing but moveable with respect to said interior wall;
wherein, optionally, said guiding support is a cam extending from a body portion of the poppet valve; and
wherein, optionally, said guiding support is a ball bearing.

60. The arrangement of claim 58, wherein said sectioned substantially annular flow channel comprises three radial sections.

61. The arrangement of claim 58, wherein said biasing device comprises a spring;
wherein, optionally, coils of said spring are substantially shielded from the flow channel by a spring cover;
wherein, optionally, coils of said spring encircle the flow channel; and
wherein, optionally, said channel splitter comprises said spring cover.

62. The arrangement of claim 58, wherein the flow channel is bounded only by an external surface of a moveable part of the poppet valve and an interior wall of the housing.

63. The arrangement of claim 58, wherein said interior wall of the housing comprises said spring cover;
wherein, optionally, the moveable part of the poppet valve and said interior wall of the housing have corresponding profiles around at least a portion of their circumferences such that the width of the flow channel in said portion is substantially constant.

64. The arrangement of claim 58, wherein the flow channel comprises a substantially cylindrical portion in one of the inlet and the outlet, said sectioned substantially annular portion around a body of the poppet valve and a substantially annular portion around an armature of the poppet valve extending into the other of the inlet and the outlet;
wherein, optionally, the flow channel further comprises a first substantially conical annular portion linking said substantially cylindrical portion to said sectioned substantially annular portion;
wherein, optionally, said first substantially conical annular portion has a cone angle between 1 and 30°, optionally between 5 and 30°, optionally 20°;
wherein, optionally, the flow channel further comprises a second substantially conical annular portion linking said sectioned substantially annular portion to said substantially annular portion; and
wherein, optionally, said second substantially conical annular section has a cone angle between 1 and 60°, optionally between 30 and 60°, optionally 45°.

65. The arrangement of claim 58, wherein the poppet valve comprises an armature at a distal end thereof, said armature extending from a substantially conical stopper portion configured to be biased into mating with a corresponding substantially conical portion of an internal wall of the housing when the poppet valve is closed, under action of the biasing device;
wherein, optionally, the first poppet valve further comprises:
a body portion formed separately to said stopper portion and said armature; and
a sealing ring; wherein:
at least one of said body portion and the stopper portion comprise a screw thread; and
the body portion and the stopper portion are screwed together so as to trap an inner perimeter of said sealing ring therebetween, an outer perimeter of the sealing ring remaining exposed to the flow channel; and
wherein, optionally, the stopper portion comprises a first screw thread and the body portion comprises a second screw thread corresponding to said first screw thread, the stopper portion being screwed into the body portion.

66. A terminal for terminating a fluid-carrying pipe, said terminal comprising the arrangement of claim 58 configured to terminate said pipe when the poppet valve is closed.

67. The terminal of claim 66, wherein the poppet valve is configured to cooperate with a corresponding poppet valve of another terminal to open both poppet valves.

68. The terminal of claim 67, whose poppet valve comprises a coupler end configured to cooperate with said corresponding poppet valve of said other terminal, and a substantially conical pipe end opposing said coupler end.

69. The terminal of claim 67, wherein each poppet valve comprises an armature having a coupler end configured to interlock with the other poppet valve armature coupler end.

70. The terminal of claim 69, wherein one of the poppet valve armature coupler ends is formed as a male connector and the other as a female connector corresponding to said male connector.

71. The terminal of claim 70, wherein said male connector is substantially conical.

72. The terminal of claim 66, wherein one of the inlet and the outlet comprises a nozzle and the other of the inlet and the outlet comprises a mating part configured to cooperate with a corresponding mating part of another terminal to open the poppet valve.

73. The terminal of claim 72, wherein said nozzle and said mating part are sealed together by an electron beam welded joint.

74. The terminal of claim 72, wherein said mating part thereof is a plug.

75. The terminal of claim 72, wherein said mating part thereof is a socket.

76. The terminal of claim 66, for use in a subsea environment.

77. A method of constructing a terminal for terminating a fluid-carrying pipe, said method comprising:
constructing a poppet valve comprising a biasing device, a body section, a stopper section and an armature;
fixing said poppet valve within a mating housing comprising a pipe end and a coupler end such that said body section, said stopper section and said armature are free to move within said mating housing under the action of said biasing device, the biasing device being arranged to bias said stopper section towards a position in which a flow channel for providing fluid communication between said pipe end and said coupler end is blocked; and
fixing a nozzle to the pipe end of the mating housing using electron beam welding;
wherein said fixing is performed such that the poppet valve is supported with respect to the housing by a channel splitter that radially sections the flow channel into a sectioned substantially annular flow channel portion around the poppet valve;
wherein said channel splitter is provided along the length of the poppet valve such that the flow channel has a substantially constant hydraulic diameter from the pipe to the coupler end, said hydraulic diameter being substantially equal to the hydraulic diameter of said pipe;
wherein, optionally, the poppet valve further comprises a sealing ring and said step of constructing the poppet valve comprises screwing the body section and the stopper section together so as to trap an inner perimeter of said sealing ring therebetween, an outer perimeter of the sealing ring remaining exposed; and
wherein, optionally, screwing the body section and the stopper section together comprises screwing a threaded part of the stopper section into a correspondingly threaded part of the body section.
